(19) United States
(12) Patent Application Publication
(10) Pub. No.: US 2014/0230254 A1
(43) Pub. Date: Aug. 21, 2014

(54) High Reliablility Scraper

(71) Applicant: Yuewei Wu, Ninghai (CN)

(72) Inventor: Yuewei Wu, Ninghai (CN)

(21) Appl. No.: 13/769,296

(22) Filed: Feb. 16, 2013

(51) Int. Cl. B26B 5/00

(52) U.S. Cl. CPC B26B 5/00
USPC 30/169

(57) ABSTRACT

A high reliability scraper has a shell acting both as a container for a blade and as a handle. The shell has a rear end and a front end from which said blade extending. The shell has a first side cover and a second side cover detachably coupling together. The first side cover has a front upper jaw, a middle groove, an outside opening, and an inner protrusion formed on a rear portion of the middle groove. The second side cover has a front lower jaw, a middle slider slidably received in said middle groove, a top protrusion formed on the middle slider and extending out from the outside opening, a pair of resilient biasing poles, a slope between the lower jaw and the middle slider, and a hook form on a rear portion of the middle slider.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to hand tools, and more particularly, to a scraper a blade of which is highly reliably locked and not liable to move.

2. Description of Related Art

Scraper is a commonly used hand tool. A conventional scraper usually has a blade shell also acting as a handle. The blade shell always has two couplable halves. The two halves are able to be coupled together and locked to form an integral handle containing a blade therebetween. When the two halves are unlocked and opened, the dull blade is able to be changed. After a new blade is installed, the two halves are able to be coupled and locked together again. In order for a firm locking, conventional scraper always has a locking mechanism. The two halves are be able to be opened only after the locking mechanism is released. When the new blade is changed, the two halves are able to be coupled together and the locking mechanism is able to be locked up again.

Such scraper has a drawback. All the locking mechanisms fix the blade by trying to press the two halves together closer and closer to obtain a firm installation of the blade. A pressure obtained from this kind of fixation is not great and a friction between the blade and the two halves obtained from the pressure is thus not great enough, too. The fixation is not firm enough and the blade fixed is liable to move. Therefore, the fixation of the blade is not reliable.

### BRIEF SUMMARY OF THE INVENTION

The main object of the invention is to provide a high reliability scraper which employs leveraging mechanism to increase a pressure to fix a blade. A friction between the blade and pressing halves is enhanced and the blade will not liable to move any longer. A reliability of the fixation of the blade, is increased.

In order to accomplish above object, the invention provides a high reliability scraper having a shell acting both as a container for a blade and as a handle. The shell has a rear end and a front end from which said blade extending. The shell, has a first side cover and a second side cover detachably coupling together. The first side cover has a front upper jaw, a middle groove, an outside opening, and an inner protrusion formed on a rear portion of the middle groove. The second side cover has a front lower jaw, a middle slider slidably received in said middle groove, a top protrusion formed on the middle slider and extending out from the outside opening, a pair of resilient biasing poles, a slope between the lower jaw and the middle slider, and a hook form on a rear portion of the middle slider.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a schematic perspective view of the preferred embodiment of the high reliability scraper of the invention.

FIG. 2 is an exploded perspective view thereof.

FIG. 3 is a perspective cross-sectional view thereof showing a status of use,

FIG. 4 is a partial perspective cross-sectional view thereof showing a status of use And,

FIG. 5 is partial plane cross-sectional view thereof showing a status of blade changing.

### DETAILED DESCRIPTION OF THE INVENTION

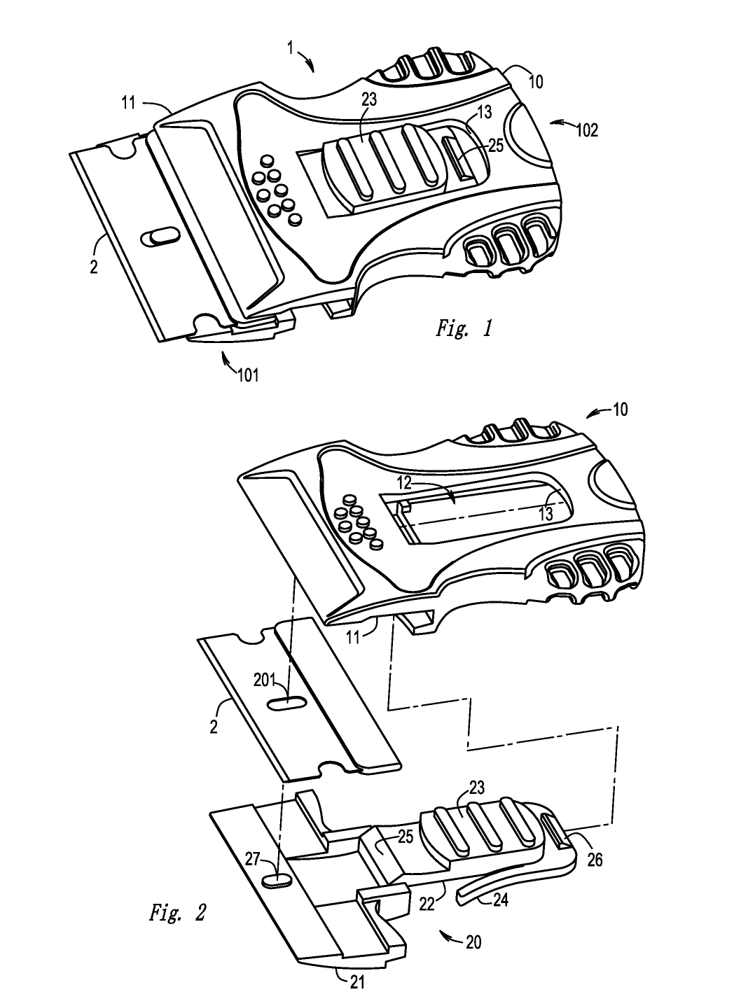

With reference to FIGS. 1 and 2, a preferred embodiment of a high reliability scraper of the invention is shown. The scraper has a shell 1 which acts both as a container for a blade 2 and as a handle. The shell 1 has a rear end 102 and a front end 101 from which the blade 2 extending. The shell 1 has a first side cover 10 and a second side cover 20 detachably coupling together.

The first side cover 10 has a front upper jaw 11, a middle groove 12, an outside opening 13, and an inner protrusion 14 formed on a rear portion of the middle groove 12 (particularly shown in FIG. 5).

The second side cover 20 has a front lower jaw 21, a middle slider 22 slidably received in the middle groove 12, a top protrusion 23 formed on the middle slider 22 and extending out from the outside opening 13, a pair of resilient biasing poles 24, a slope 25 between the lower jaw 21 and the middle slider 22, and a hook 26 form on a rear portion of the middle slider 22.

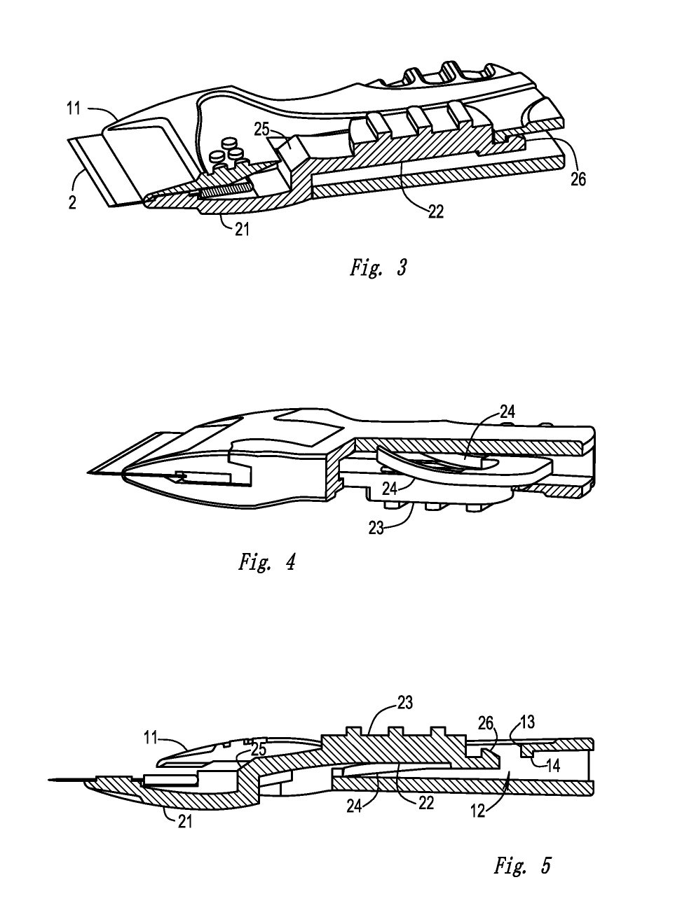

In use, as shown in FIGS. 3 and 4, the resilient biasing poles 24 of the second side cover 20 push against an inner surface of the middle groove 12 of the first side cover 10, urging the hook 26 to hook up the inner protrusion 14. When the hook 26 hooks up the inner protrusion 14, the second, side cover 20 will not be able to move forward with respect to the first side cover 10. At this time, the first and the second side covers 10 and 20 act as a scissor, firmly sandwiching the blade 2 between the front upper jaw 11 of the first side cover 10 and the front lower jaw 21 of the second side cover 20.

When a dull blade 2 needs to be changed, a user is able to grasp the shell 1 with his hand and press down and then push forward the top protrusion 23 in a direct to the front end 101 with his thumb. As shown in FIG. 5, when the top protrusion 23 is pressed down, the hook 26 leaves the inner protrusion 14 and the second side cover 20 is able to move forward with respect to the first side cover 10. And when the top protrusion 25 is pushed forward, the slope 25 will meet an inner surface of the first side cover 10. If the top protrusion 23 is being kept pushing, the second side cover 20 will rotate slightly about the first side cover 10 under a pushing of the slope 25. This slight rotation produces a departure between the front upper and lower jaws 11 and 21. The departure makes sure that the blade 2 be able to be pulled out from between the front upper and lower jaws 11 and 21 and changed. After a new blade 2 is installed, the user will be able to, move back the top protrusion 23. When the hook 26 passes the inner protrusion 14, the top protrusion 23 will arise under the biasing forces of the pair of resilient biasing poles 24. The hook 26 will hook up the inner protrusion 14 again, as shown in FIGS. 3 and 4. At this time, the blade 2 is firmly and securely sandwiched between the front upper jaw 11 of the first side cover 10 and the front lower jaw 21 of the second side cover 20.

There may be a fixing protrusion 27 formed on the front lower jaw 21 towards the front upper jaw 11. The fixing protrusion 27 is able to pass through a fixing hole 201 defined in the blade 2, in order to further stabilize the blade 2.

From above description, it is seen that the object of the present invention has been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A high reliability scraper comprising:
a shell acting both as a container for a blade and as a handle, said shell having a rear end and a front end from which said blade extending, said shell having a first side cover and a second side cover detachably coupling together, said first side cover having a front upper jaw. a middle groove, an outside opening, and an inner protrusion formed on a rear portion of said middle groove, said second side cover having a front lower jaw, a middle slider slidably received in said middle groove, a top protrusion formed on said middle slider and extending out from said outside opening, a pair of resilient biasing poles, a slope between said lower jaw and said middle slider, and a hook form on a rear portion of said middle slider.

2. The high reliability scraper as claimed in claim 1, wherein a fixing protrusion is formed on said front lower jaw towards said front upper jaw.
